(19) United States
(12) Patent Application Publication
(10) Pub. No.: US 2005/0096406 A1
(43) Pub. Date: May 5, 2005

(54) Reactive diluents and alkyd resin coating compositions

(76) Inventors: Roger Pretot, 4054 Basel (CH); Andreas Muhlebach, 5070 Frick (CH); Wolfgang Peter, 79395 Neuenburg am Rhein (DE); Kurt Dietliker, 4123 Allschwil (CH); Tunja Jung, 79618 Rheinfelden-Herten (DE); Clemens Auschra, 79106 Freiburg (DE); Hans Jurg Kirner, 4133 Pratteln (CH); Paul Adriaan Van Der Schaaf, 4123 Allschwil (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/504,239

(22) PCT Filed: Feb. 25, 2003
(86) PCT No.: PCT/EP03/01899

(30) Foreign Application Priority Data
Mar. 4, 2002 (EP) 02405161.7

(51) Int. Cl. C08G 2/00

(52) U.S. Cl. 522/6

(57) ABSTRACT

The invention relates to new reactive diluents of the formulae (Ia, Ib, Ic, Id, Ie) and to an alkyd coating composition comprising them. In a preferred embodiment R₁ and R₂ are hydrogen; R₃ is (meth)acryloyloxy-methyl or phenyl para substituted by vinyl, R₄ is phenyl or phenyl para substituted by vinyl or (meth)acryloyloxy; or a substituted phenyl residue of the formula —C₆H₄CH₂—W, wherein W is (meth)acryloyloxy, or an aliphatic residue of the formula —CH₂—Y-A, wherein Y is a bond, O—C₁-C₁₂alkylene, wherein the alkylene linker is linear or branched and may be interrupted once or more than once by oxygen, A is hydroxy, C₁-C₆alkoxy, acetoxy, (meth)acryloyloxy, or a phthalate- or maleate-residue; R₅ is hydrogen; n is 1; X is —(CH₂)—. The invention further relates to a solvent-based or water-based alkyd coating composition comprising 0.3 to 10 wt. % of a mono-, bis- or trisacylphosphinoxide photoinitiator, especially Irgacure 819.

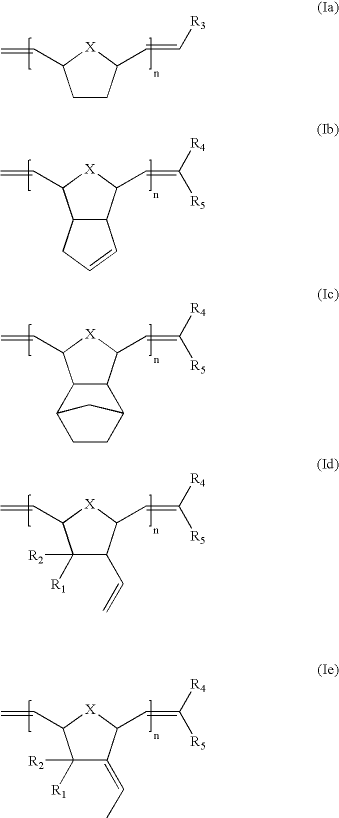

The invention relates to new reactive diluents and to a coating composition based on an alkyd resin containing them.

Alkyd resins are commonly used for solvent-based or water based coating systems. Alkyd resins are formed through the incorporation of unsaturated fatty acid esters into polyester or polyurethane chain-extended polymer systems. Curing is obtained via auto-oxidative crosslinking.

Conventional alkyd resin systems contain a solvent, an anti skinning agent and a siccative. The solvent will usually be an organic solvent.

Examples of antiskinning agents may be classified as antioxidants, blocking agents, solvents or retention agents. The European Patent Publication EP 1 103 583A1 describes aldoximes or ketoximes as antiskinning agents.

The cure-process involves oxidation, i.e. reaction with oxygen from the air. It is always performed in the presence of a catalyst, usually called a “drier” or “siccative”, which is usually a combination of metal salts. Those catalysts are well-known in the art and commercially available. Examples of suitable driers are metal salts of (cyclo)aliphatic, natural or synthetic acids, such as, for example, linoleic acid, naphthenic acid and 2-ethyl-hexanoic acid. Cobalt, manganese, lead, zirconium, calcium and zinc are suitable metals. Mixtures of driers can, of course, also be used. In terms of their metal content, the driers are used in a proportion of 0.001 to about 3% by weight, relative to the binder solids content.

It has been suggested to replace the solvent by reactive diluents which are usually compounds or mixtures of compounds of relatively low viscosity, a relatively high boiling point (i.e. low saturated vapor pressure) which act as solvents during the formulation and processing of the coating. Such reactive diluents can copolymerize with a resin thereby reducing losses of the solvent to atmosphere on drying of the coating.

WO 9702230 describes the use of 2-(2,7-octadienoxy) di(2,7-octadienyl) succinate as a reactive diluent in a paint or coating formulation.

WO 9800387 describes the use of a composition comprising a mixture of a fumarate, maleate and 2-allyloxy-succinate esters as a reactive diluent in a paint or coating formulation.

EP 072 127 describes an alkyd resin system containing a reactive diluent selected from the group consisting of dicyclopentenyl methacrylate and dicyclopentenyloxyalkyl methacrylate.

Japanese Patent Application JP2001226466A2 describes the polymerization of norbornene in the presence of allyl methacrylate and bis(tricyclohexylphosphine)benzylidene ruthenium dichloride to give methacryloyl-terminated polymers. Low viscous compounds are not described.

There is still a need to provide cobalt-free alkyd resin systems having a markedly reduced solvent content or being solvent free and showing a similar drying performance.

It has now been found that the compounds of formula Ia-Ie as defined below can be used as reactive diluents thus, replacing the solvent completely or partially.

The invention relates to compounds of the formula Ia-Ie 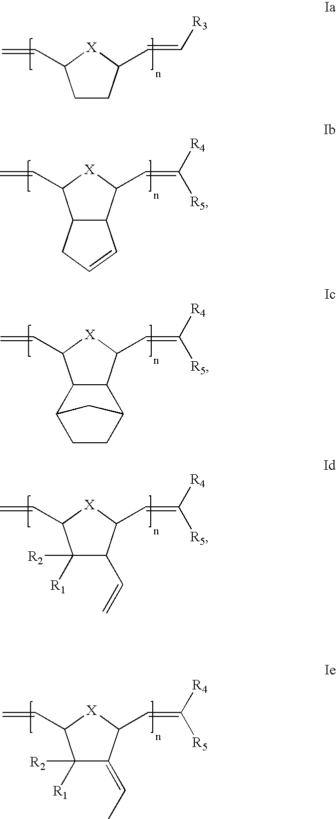
wherein
R₁ and R₂ independently of one another are hydrogen, hydroxy, cyano, halogen, vinyl, formyl, a residue of acrylic acid, C₁-C₆alkoxycarbonyl, C₁-C₆alkylaminocarbonyl, phenylcarbonyl, C₁-C₆alkylcarbonyloxy, C₁-C₆alkenylcarbonyloxy, (meth)acryloyloxy, (meth)acryloyl-C₁-C₆alkylamino, di[(meth)acryloylC₁-C₆alkyl]amino, unsubstituted C₁-C₁₂alkyl or C₁-C₁₂alkyl substituted by hydroxy, halogen, ethynyl, C₁-C₆alkylamino, di(C₁-C₆)alkylamino, (meth)acryloyloxy, (meth)acryloylC₁-C₆alkylamino, di[(meth)-acryloylC₁-C₆alkyl]-amino or by tolylaminocarbonyloxy;
R₃ is (meth)acryloyloxy-C₁-C₆alkyl or phenyl substituted once or more than once by hydroxy, halogen, cyano, vinyl, C₁-C₁₂alkyl, C₁-C₆alkoxy, phenoxy, benzyloxy, acetoxy, C₁-C₆alkoxycarbonyloxy, C₁C₆alkylcarbonyloxy, trifluormethyl, (meth)acryloyloxy, (meth)acryloylC₁-C₆alkylamino, di[(meth)acryloylC₁-C₆alkyl]amino; or R₃ is 1-naphthyl, 2-naphthyl, biphenyl, anthracenyl; or R₃ is a substituted phenyl residue of the formula —C₆H₄—CH₂—W, wherein
   W signifies hydroxy, halogen, cyano, acetoxy, acetylsulfanyl, trifluormethylcarbonyloxy, (meth)acryloyloxy, (meth)acryloylC₁-C₆alkylamino, di[(meth)acryloylC₁-C₆alkyl]amino, C₁-C₁₂alkoxy, C₁-C₁₂alkoxy substituted once or more than once by fluor, C₁-C₁₂alkoxy substituted by epoxyethyl; or W is dimethylamino, dimethylammonium, or W is a residue selected from an amino butyric acid or from an an ε-caprolactame, or W is sulfonato, C₁-C₆alkylsulfonyl or C₁-C₆alkylsulfanyl, wherein the alkyl group is unsubstituted or substituted by chlorine; or W is a silanol residue or a residue of a phosphonic acid;
R₄ is hydrogen, phenyl, 1-naphthyl, 2-naphthyl, biphenyl, anthracenyl, phenyl substituted once or more than once by hydroxy, halogen, cyano, vinyl, C₁-C₁₂alkyl, C₁-C₆alkoxy, phenoxy, benzyloxy, acetoxy, C₁C₆alkoxycarbonyloxy, C₁-C₆alkylcarbonyloxy, trifluormethyl, (meth)acryloyloxy, (meth)acryloylC₁-C₆alkylamino, di[(meth)acryloylC₁-C₆alkyl]amino, or R₄ is a substituted phenyl residue of the formula —C₆H₄—CH₂—W, wherein
   W signifies hydroxy, halogen, cyano, acetoxy, acetylsulfanyl, trifluormethylcarbonyloxy, (meth)acryloyloxy, (meth)acryloylC₁-C₆alkylamino, di[(meth)acryloylC₁-C₆alkyl]amino, C₁-C₁₂alkoxy, C₁-C₁₂alkoxy substituted once or more than once by fluor, C₁-C₁₂alkoxy substituted by epoxyethyl; or W is dimethylamino, dimethylammonium, or W is a residue selected from an amino butyric acid or from an an ε-caprolactame, or W is sulfonato, C₁-C₆alkylsulfonyl or C₁-C₆alkylsulfanyl, wherein the alkyl group is unsubstituted or substituted by chlorine; or W is a silanol residue or a residue of a phosphonic acid; or
R₄ is an aliphatic residue of the formula —(CR₆R₇)ₘY-A, wherein
   R₆ and R₇ independently of one another are hydrogen, C₁-C₁₂alkyl or phenyl;
   m is 1-10,
   Y is a bond, O—C₁-C₁₂alkylene, wherein the alkylene linker is linear or branched and may be interrupted once or more than once by oxygen,
   A is hydroxy, C₁-C₆alkoxy, phenoxy, phenylcarbonyloxy, formyloxy, acetoxy, benzoyloxy, (meth)acryloyloxy, (meth)acryloyl-C₁-C₆alkylamino, di[(meth)acryloylC₁-C₆alkyl]amino; or a phthalate or maleate-residue; or
R₄ is a residue of the formula A or B 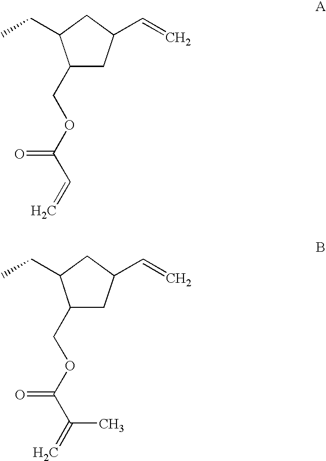
R₅ is hydrogen or C₁-C₆alkyl;
n is a number of 1-10;
X is —(CH₂)₁₋₄—, —CR₈R₉—, —CO—, —O—, —NR₁₀, —S—,
   R₈ and R₉ independently of one another are hydrogen, unsubstituted C₁-C₆-alkyl or C₁-C₆-alkoxy, C₁-C₆-alkyl substituted by OH, C₁-C₆-alkoxy or halogen; unsubstituted aryl or aryl substituted by C₁-C₄-alkyl, OH, C₁-C₆alkoxy or halogen; or C₁-C₆alkylcarbonyloxy or phenylcarbonyloxy,
   R₁₀ is hydrogen, unsubstituted C₁-C₆-alkyl or C₁-C₆-alkyl substituted by OH— or C₁-C₄alkoxy;
   unsubstituted phenyl or phenyl substituted by OH—, C₁-C₄alkyl- or C₁-C₄alkoxy.

Furthermore, the invention relates to a coating composition comprising
(1) an alkyd resins,
(2) a photoinitiator,
(3) a reactive diluent of formula Ia-Ie as described above or mixtures thereof, and
(4) optionally a solvent.
   Definitions:
   Alkyd Resin

Alkyd resins are well known in the art and are readily available commercially.

Examples of resins that may be present include alkyd resins, epoxy-esters, urethane-alkyds and further modified oils.

Air drying alkyd resins are esters from drying oils, such as linseed oil, soybean oil, tungoil and other oils having unsaturated groups in there alkyl chain.

The alkyd resins can be classified as “long oil” alkyd resins containing more than 60 wt % of oil portion “medium oil” alkyd resins containing from 40 to 60 wt % of oil portion and “short oil” alkyd resins containing less than 40 wt % of oil portion. The alkyd resins are described in Ullmann's Encyclopedia, 6^{th} edition 1999.

Longoil alkyd resins are especially known as good dispersing resins for a wide variety of pigments.

The resin may be present in an amount of between 5 and 50 wt %, based on the weight of the liquid coating composition. In high solid systems the resin is present in an amount >50 wt %. The alkyd may also be a water dilutable alkyd resins obtained by mixing (unmodified) alkyd resins with emulsifiers or may be a self-emulsifying alkyd resins with an chemically incorporated emulsifier.

Solvent

Solvents used in alkyd resins are aliphatic, cycloaliphatic and aromatic hydrocarbons such as mineral spirits known as white spirit, as well as xylene, toluene, alcohol ethers, glycol ethers, ketones, esters, alcohol ether acetates or mixtures thereof. As mentioned above, the solvent is not necessary to perform the inventive coating.

Photoinitiator

Any photoinitiator known to be useful for curing ethylenically unsaturated polymerizable compounds with daylight or with light sources equivalent to daylight or with UV-light may be used. The radiation employed is guided essentially by the absorption of the photoinitiators used. Suitable radiation sources are known. They can, for example, comprise lamps or lasers. Suitable UV lamps are mercury vapor lamps or UV lasers. The period of irradiation depends on the nature of the light source; It can range from seconds to minutes. Preference is given to the use of daylight.

Suitable photoinitiators are selected from benzophenones, benzophenone derivates such as, for example, halomethyl benzophenones, acetophenones, acetophenone derivates such as, for example, dialkoxyacetophenones, halomethylacetophenones, α-hydroxy or α-amino-acetophenones (1-benzoyl-1-hydroxy-1-methylethane or (4-morpholino-benzoyl)-2-benzoyl-2-dimethylamino-propane or (4-methylthio-benzoyl)-1-methyl-1-morpholinoethane), α-sulfonyl acetophenones; halomethylarylsulfones, 4-aroyl-1,3-dioxolanes, anthracene derivatives, thioxanthone derivatives, 3-ketocumarine derivatves, anthraquinone derivatives, benzoin alkylethers and benzil ketals, phenylglyoxalates and derivates thereof, dimeric phenylglyoxalates, peresters, monoacylphosphinoxides, bisacylphosphinoxides, trisacylphosphinoxides, halomethyltriazines, titanocenes, borates, O-acyloximes or camphor quinones. The photoinitiators may be used alone or in combination with suitable co-initiators.

Especially suitable are coating compositions comprising 0.3 to 10 wt. % of a mono-, bis- or trisacylphosphinoxide photoinitiator of the formula I 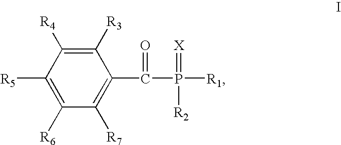
wherein
X is O or S;
R₁ and R₂ independently of one another are linear or branched C₁-C₁₂-alkyl, C₁-C₁₂-alkoxy, phenyl, unsubstituted or optionally substituted by OR₈, SR₉, NR₁₀R₁₁, C₁-C₁₂-Alkyl or halogen; or
R₁ and R₂ are phenyl-C₁-C₄-alkyl or 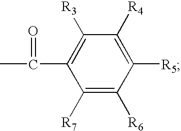
   R₃ and R₇ independently of one another are C₁-C₁₂-alkyl, C₁-C₁₂-alkoxy or halogen;
R₄, R₅ and R₆ independently of one another are hydrogen, C₁-C₁₂-alkyl, C₁-C₁₂-alkoxy or halogen;
R₈, R₉ R₁₀ and R₁₁ independently of one another are hydrogen, C₁-C₁₂-alkyl, C₂C₁₂-alkenyl, benzyl or C₂C₂₀-alkyl interrupted once or several times by —O; or R₁₀ and R₁₁ represent together with the N-atom that they are attached to an optionally oxygen- or —NR₁₂-containing 5 or 6 membered ring;
R₁₂ is hydrogen, phenyl-C₁-C₄-alkyl or C₁-C₁₂-alkyl.

Preferred are compounds of the formula I′ 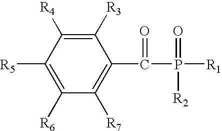
wherein
R₁ and R₂ independently of one another are C₁-C₈-alkyl, C₁C₆-alkoxy, phenyl that is unsubstituted or optionally substituted by one or two OR₈ or NR₁₀R₁₁; or
R₁ is 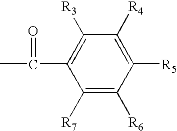
and R₂ is C₁-C₁₂-alkyl or phenyl unsubstituted or optionally substituted by OR₈;
R₃ and R₇ independently of one another are C₁-C₄-alkyl, C₁-C₄-alkoxy, or chlorine;
R₄, R₅ and R₆ independently of one another are hydrogen or C₁-C₄-alkyl,
R₈ is C₁-C₈alkyl;
R₁₀ and R₁₁ represent together with the N-atom that they are attached to an optionally oxygen-containing 5 or 6 membered ring.

Especially preferred are compounds of the formula I′, in which 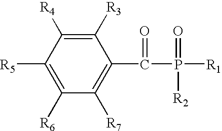
wherein
R₁ and R₂ independently of one another are C₁-C₂-alkoxy or phenyl; or
R₁ is 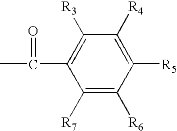
and R₂ is C₁-C₈-alkyl or phenyl that is unsubstituted or optionally substituted by one or two OR₈;
R₃ and R₇ independently of one another are methyl, methoxy, or chlorine;
R₅ is hydrogen or methyl;
R₄ and R₆ are hydrogen,
R₈ is C₁-C₆-alkyl;

Most preferred is bis(2,4,6-trimethylbenzoyl)phenylphosphine oxide.

Bisaxcylphosphine oxides are described in EP-B-184095 or U.S. Pat. No. 4,737,593.

Illustrative examples of photoinitiators described in U.S. Pat. No. 5,534,559 and useful in the daylight curable compositions are:
bis(2,4,6-trimethylbenzoyl)methylphosphine oxide
bis(2,4,6-trimethylbenzoyl)ethylphosphine oxide
bis(2,4,6-trimethylbenzoyl)-isopropylphosphine oxide
bis(2,4,6-trimethylbenzoyl)-n-propylphosphine oxide
bis(2,4,6-trimethylbenzoyl)-n-butylphosphine oxide
bis(2,4,6-trimethylbenzoyl)-tert-butylphosphine oxide
bis(2,4,6-trimethylbenzoyl)-(2-methyl-prop-1-yl)phosphine oxide
bis(2,4,6-trimethylbenzoyl)-(1-methyl-prop-1-yl)phosphine oxide
bis(2,4,6-trimethylbenzoyl)-cyclohexylphosphine oxide
bis(2,4,6-trimethylbenzoyl)-n-pentylphosphine oxide
bis(2,4,6-trimethylbenzoyl)-n-hexylphosphine oxide
bis(2,4,6-trimethylbenzoyl)-(2-ethyl-hex-1-yl)phosphine oxide
bis(2,4,6-trimethylbenzoyl)-n-octylphosphine oxide
bis(2,4,6-trimethylbenzoyl)-(2,4,4-trimethyl-pent-1-yl)phosphine oxide
bis(2,4,6-trimethylbenzoyl)-n-decylphosphine oxide
bis(2,4,6-trimethylbenzoyl)-phenylphosphine oxide (Irgacure 819)
bis(2,4,6-trimethylbenzoyl)-(4-methylphenyl)phosphine oxide
bis(2,6-dimethylbenzoyl)-methylphosphine oxide
bis(2,6-dimethylbenzoyl)-ethylphosphine oxide
bis(2,6-dimethylbenzoyl)-i-propylphosphine oxide
bis(2,6-dimethylbenzoyl)-n-propylphosphine oxide
bis(2,6-dimethylbenzoyl)-(2,4,4-trimethyl-pent-1-yl)phosphine oxide
bis(2,6-dimethylbenzoyl)-(2-methyl-prop-1-yl)phosphine oxide
bis(2,6-dimethylbenzoyl)-n-butylphosphine oxide
bis(2,6-dimethylbenzoyl)-t-butylphosphine oxide
bis(2,6-dimethylbenzoyl)-(1-methyl-prop-1-yl)phosphine oxide
bis(2,6-dimethylbenzoyl)-cyclohexylphosphine oxide
bis(2,6-dimethylbenzoyl)-n-pentylphosphine oxide
bis(2,6-dimethylbenzoyl)-n-hexylphosphine oxide
bis(2,6-dimethylbenzoyl)-(2-ethyl-hex-1-yl)phosphine oxide
bis(2,6-dimethylbenzoyl)-n-octylphosphine oxide
bis(2,6-dimethylbenzoyl)-(2,4,4-trimethyl-pent-1-yl)phosphine oxide
bis(2,6-dimethylbenzoyl)-phenylphosphine oxide
bis(2,6-dimethylbenzoyl)-(2,5-dimethylphenyl)phosphine oxide
bis(2,6-dimethylbenzoyl)-n-octylphosphine oxide
bis(2,4,6-triethylbenzoyl)-methylphosphine oxide
bis(2,4,6-triethylbenzoyl)-ethylphosphine oxide
bis(2,4,6-triethylbenzoyl)-i-propylphosphine oxide
bis(2,4,6-triethylbenzoyl)-n-propylphosphine oxide
bis(2,4,6-triethylbenzoyl)-n-butylphosphine oxide
bis(2,4,6-triethylbenzoyl)-t-butylphosphine oxide
bis(2,4,6-triethylbenzoyl)-(2-methyl-prop-1-yl)phosphine oxide
bis(2,4,6-triethylbenzoyl)-(1-methyl-prop-1-yl)phosphine oxide
bis(2,4,6-triethylbenzoyl)-cyclohexylphosphine oxide
bis(2,4,6-triethylbenzoyl)-n-pentylphosphine oxide
bis(2,4,6-triethylbenzoyl)-n-hexylphosphine oxide
bis(2,4,6-triethylbenzoyl)-(2-ethyl-hex-1-yl)phosphine oxide
bis(2,4,6-triethylbenzoyl)-n-octylphosphine oxide
bis(2,4,6-triethylbenzoyl)-(2,4,4-trimethyl-pent-1-yl)phosphine oxide
bis(2,4,6-triethylbenzoyl)-n-decylphosphine oxide
bis(2,4,6-triethylbenzoyl)-phenylphosphine oxide
bis(2,6-diethylbenzoyl)-(2,4,4-trimethyl-pent-1-yl)phosphine oxide
bis(2,6-diethylbenzoyl)-(2-methyl-prop-1-yl)phosphine oxide
bis(2,6-diethylbenzoyl)-n-butylphosphine oxide
bis(2,6-diethylbenzoyl)-t-butylphosphine oxide
bis(2,6-diethylbenzoyl)-(1-methyl-prop-1-yl)phosphine oxide
bis(2,6-diethylbenzoyl)cyclohexylphosphine oxide
bis(2,6-diethylbenzoyl)-n-pentylphosphine oxide
bis(2,6-diethylbenzoyl)-n-hexylphosphine oxide
bis(2,6-diethylbenzoyl)-(2-ethyl-hex-1-yl)phosphine oxide
bis(2,6-diethylbenzoyl)-n-octylphosphine oxide
bis(2,6-diethylbenzoyl)-phenylphosphine oxide
bis(2,4,6-triisopropylbenzoyl)-n-butylphosphine oxide
bis(2,4,6-triisopropylbenzoyl)-t-butylphosphine oxide
bis(2,4,6-triisopropylbenzoyl)-(2-methyl-prop-1-yl)phosphine oxide
bis(2,4,6-triisopropylbenzoyl)-(1 methyl-prop-1-yl)-phosphine oxide
bis(2,4,6-triisopropylbenzoyl)-cyclohexylphosphine oxide
bis(2,4,6-triisopropylbenzoyl)-n-pentylphosphine oxide
bis(2,4,6-triisopropylbenzoyl)-n-hexylphosphine oxide
bis(2,4,6-triisopropylbenzoyl)-(2-ethyl-hex-1-yl)-phosphine oxide
bis(2,4,6-triisopropylbenzoyl)-n-octylphosphine oxide
bis(2,4,6-triisopropylbenzoyl)-(2,4,4-trimethyl-pent-1-yl)-phosphine oxide
bis(2,4,6-triisopropylbenzoyl)-n-decylphosphine oxide
bis(2,4,6-triisopropylbenzoyl)-phenylphosphine oxide
bis(2,4,6-tri-n-butylbenzoyl)-(2-methyl-prop-1-yl)phosphine oxide
bis(2,4,6-tri-n-butylbenzoyl)-(2,4,4-trimethyl-pent-1-yl)-phosphine oxide
bis(2,4,6-tri-n-propylbenzoyl)-(2-methyl-prop-1-yl)phosphine oxide
bis(2,4,6-tri-n-propylbenzoyl)-n-butylphosphine oxide
bis(2,4,6-tri-(1-methyl-prop-1-yl)benzoyl)-n-octylphosphine oxide
bis(2,4,6-tri-(1-methyl-prop-1-yl)benzoyl)-n-butylphosphine oxide
bis(2,4,6-tri-(2-methyl-prop-1-yl)benzoyl)(2,4,4-trimethyl-pent-1-yl)phosphine oxide
bis(2,4,6-tri-(2-methyl-prop-1-yl)benzoyl)-(2-methyl-prop-1-yl)phosphine oxide
bis(2,4,6-tri-t-butylbenzoyl)-n-butylphosphine oxide
bis(2,6-dimethyl-4-n-butylbenzoyl)-(2-methyl-prop-1-yl)phosphine oxide
bis(2,6-dimethyl-4-n-butylbenzoyl)-phenylphosphine oxide
bis(2,4,6-trimethyl-benzoyl)(2,5-dimethylphenyl)phosphine oxide
bis(2,6-dimethyl-4-n-butylbenzoyl)-(2,5-dimethylphenyl)phosphine oxide,
bis(2,6-dimethoxybenzoyl)-(2,4,4-trimethyl-pent-1-yl)phoshine oxide and
bis(2,6-dichlorobenzoyl)-(4-propylphenyl)phoshine oxide.

Especially preferred photoinitiators are:

Monoacylphosphine oxides such as, for example,

Lucirin TPO (commercially available from BASF) or

[Benzyl-(4-morpholin-4-yl-phenyl)-phosphinoyl]-(2,4,6-trimethyl-phenyl)-methanone 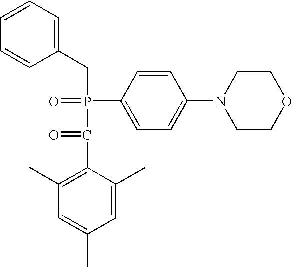
   which can be prepared according to the PCT Application PCT-EP02/09045 filed Aug. 13, 2002,
[(2-Ethyl-hexyl)-(2,4,4-trimethyl-pentyl)-phosphinoyl](2,4,6-trimethylphenyl)-methanone 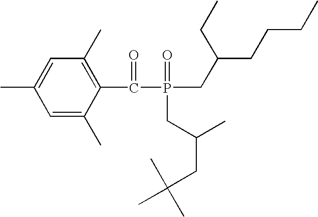
   which can be prepared according to the German Patent Publication 10127171 or the British patent GB2365430;
2,4,6-trimethylbenzoyl-phenyl phosphinic acid ethyl ester (BASF).

Bisacylphoshine oxides such as, for example, 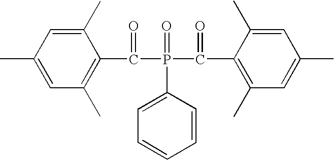
Irgacure 819, commercially available from Ciba.

Acylphosphine sulfides such as, for example,
[phenyl-(2,4,6-trimethyl-benzoyl)-phosphinothioyl]-(2,4,6-trimethyl-phenyl)-methanone 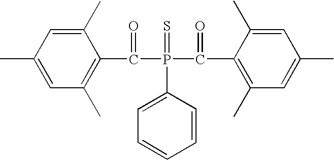
   which can be prepared according to U.S. Pat. No. 5,368,985,
or 9-(2,4,6-trimethylbenzoyl)-9-phosphabicyclo[3.3.1]nonane-9-sulfide, 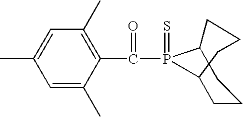
   which can be prepared according to U.S. Pat. No. 5,399,782. Phenylglyoxalates such as, for example Nuvopol 3000 commercially available from Stauffer.

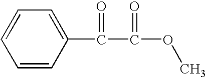

Phenylglyoxalate diester of diols such as Oxo-phenyl-acetic acid 2-[2-(2-oxo-2-phenyl-acetoxy)-ethoxy]-ethyl ester 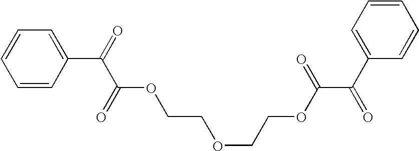
which can be prepared according to U.S. Pat. No. 6,048,660.

The Photoinitiator may be present in an amount from about 0,3-10 wt %, preferably from about 0,3-5 wt %, more preferably from about 1-2 wt %.

Diluent

The residues in the above formula Ia-Ie are defined as follows:

C₁-C₁₂Alkyl is linear or branched and is for example C₁-C₁₂—, C₁-C₈—, C₁-C₆— or C₁-C₄alkyl. Examples are methyl, ethyl, propyl, isopropyl, n-butyl, sec-butyl, iso-butyl, tert-butyl, pentyl, hexyl, heptyl, 2,4,4-trimethyl-pentyl, 2-ethylhexyl, octyl, nonyl, decyl, undecyl or dodecyl.

The substituted C₁-C₁₂alkyl residue may be substituted once or more than once. It is also possible that the substituents are not the same. An example may be a residue like 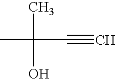
A residue of an acrylic acid is —CH═CHCOOH.
C₁-C₆alkoxycarbonyl is for example —C(O)OCH₃, —C(O)OCH₂CH₃.
C₁-C₆alkylaminocarbonyl is for example —C(O)NHCH₃.
C₁-C₆alkylcarbonyloxy is for example —O—C(O)CH₃.
C₁-C₆alkenylcarbonyloxy is for example —O—C(O)CH═CH₂.
(Meth)acryloyloxy refers to acryloyloxy (CH₂═CH—COO—) or methacryloyloxy (CH₂═C(CH₃)—COO—).

Phenyl substituted once or more than once by C₁C₁₂alkyl is for example —C₆H₄CH₃, —C₆H₃(CH₃)₂, —C₆H₂(CH₃)₃, —C₆H(CH₃)₄, —C₆(CH₃)₅, —C₆H₄(CH₂)₇CH₃, —C₆H₄(CH₂)₁₁CH₃, —C₆H₄—C₆H₁₁; —C₆H₄CH(CH₃)₂, —C₆H₄C(CH₃)₃.

Phenyl substituted once or more than once by halogen is for example —C₆H₄F, —C₆H₄Cl, —C₆H₄Br, —C₆H₄I, —C₆H₃F₂, —C₆H₃Cl₂, —C₆H₄Br, —C₆H₄CF₃, —C₆H₃(CF₃)₂.

Phenyl substituted by C₁-C₆alkoxycarbonyloxy is for example phenyl substituted by tert.butoxycarbonyloxy (—C₆H₄OC(O)OC(CH)₃).

Phenyl substituted by C₁-C₆alkylcarbonyloxy is for example phenyl acetate.

Acetylsulfanyl refers to CH₃—COS—.

C₁-C₁₂alkoxy substituted more than once by fluor is for example —OCH(CF₃)₂, —O(CF₂)₇CF₃.

Benzyl substituted by a residue selected from an amino butyric acid is for example —C₆H₄CH₂NH(CH₂)₃COOH—.

Benzyl substituted by C₁-C₆alkylsulfonyl or C₁-C₆alkylsulfonium salts, for example —C₆H₄CH₂SO₂(CH₂)₂Cl, or C₆H₄CH₂S⁺(CH₂CH₃)₂Cl⁻.

Benzyl substituted by a silanol residue is for example —C₆H₄CH₂CH(Si(OCH₂CH₃)₃))CH₃, —C₆H₄CH₂OSi(CH₃)₃ or —C₆H₄CH₂OSi(CH₃)₂C(CH₃)₃.

Benzyl substituted by a residue of a phosphonic acid is for example —C₆H₄CH₂P(O) (OCH₂CH₃)₂.

When Y is O—C₁-C₁₂alkylene, wherein the alkylene linker is linear or branched and may be interrupted once or more than once by oxygen, the following linkers may be listed as examples: —O(CH₂)₃—, —O(CH₂)₃OC(OH₂)₃—, —OCH₂C(CH₂OCH₂CH═CH₂)(CH₂CH₃)CH₂—.

The group —(CR₆R₇)ₘ— also includes structures like —CH₂CH₂CH(CH₃)CH₂CH₂—.

A phthalate residue is for example

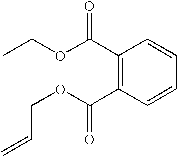

A maleate residue is for example

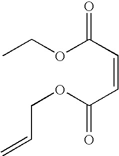

C₁-C₆Alkoxy is likewise linear or branched and is, for example, methoxy, ethoxy, propoxy, isopropoxy, n-butyloxy, sec-butyloxy, iso-butyloxy, tert-butyloxy, pentoxy or hexoxy.

Aryl is for example phenyl, 1-naphthyl, 2-naphthyl, anthracenyl, phenanthryl, in particular phenyl. The aryl residues can be mono or polysubstituted.

Concerning the residue R₃, the phenyl ring is preferably para substituted.

Concerning the residue R₄, the phenyl ring is preferably unsubstituted or para substituted.

The residue of formula I b is

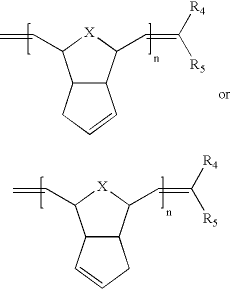

Examples for the residue R₁-R₅ are as follows:
R₁ —H,
   —CH₃, —CH₂CH₃, —CH₂CH₂CH₂CH₃, —(CH₂)₅CH₃, —(CH₂)₉CH₃,
   —CH═CHCOOH,
   —CH₂OH, —CH(OH)CH₃, —C(CH₃)(OH)C≡CH,
   —CH₂OC(O)CH═CH₂, —CH₂OC(O)C(CH₃)═CH₂,
   —CH₂OC(O)NHC₆H₄CH₃,
   —CH₂NHCH₂CH₂CH₃,
   —CH₂Cl,
   —C(O)OCH₃, —C(O)OCH₂CH₃,
   —C(O)NHCH₃,
   —CHO,
   —C(O)C₆H₅,
   —CN
   —OH, —OC(O)CH₃, —O—C(O)CH═CH₂, —O—C(O)C(CH₃)═CH₂,
   —Cl
R₂ —H, —CH₃, —CH₂CH₃, —CH₂CH₂CH₂CH₃, —(CH₂)₅CH₃, —(CH₂)₉CH₃,
   —CH₂OH, —CN, —OH, —OC(O)CH₃, —Cl
R₃-1-C₁₀H₇, -2C₁₀H₇—, C₁₄H₉,
   —C₆H₄C₆H₅, —C₆H₄CH═CH₂, —C₆H₄CH₂OH,
   —C₆H₄CH₃, —C₆H₃(CH₃)₂, —C₆H₂(CH₃)₃, —C₆H₁(CH₃)₄, —C₆(CH₃)₅,
   —C₆H₄(CH₂)₇CH₃, —C₆H₄(CH₂)₁₁CH₃, —C₆H₄CH(CH₂)₅, —C₆H₄CH(CH₃)₂, —C₆H₄C(CH₃)₃ —C₆H₄F, —C₆H₄Cl, —C₆H₄Br, —C₆H₄I, —C₆F₄, —C₆H₃F₂, —C₆H₃Cl₂, —C₆H₄Br,
   —C₆H₄CF₃, —C₆H₃(CF₃)₂,
   —C₆H₄CH₂Cl, —C₆H₄CH₂SO₂(CH₂)₂Cl, —C₆H₄CH₂CN,
   —C₆H₄CH₂CH(Si(OCH₂CH₃)₃))CH₃,
   —C₆H₄CH₂OSi(CH₃)₃, —C₆H₄CH₂OSi(CH₃)₂C(CH₃)₃,
   —C₆H₄CH₂OC(O)CH₃, —C₆H₄CH₂O—C(O)CHCH₂,
   —C₆H₄CH₂O—C(O)C(CH₃)CH₂,
   —C₆H₄CH₂OCH₂CH(O)CH 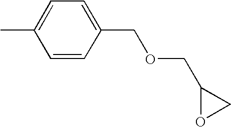
   —C₆H₄CH₂OC(O)CF₃, —C₆H₄CH₂OCH(CF₃)₂, —C₆H₄CH₂O(CF₂)₇CF₃,
   —C₆H₄CH₂N(CH₃)₂, —C₆H₄CH₂N(CH₃)₃⁺Cl⁻, —C₆H₄CH₂NH(CH₂)₃COOH, 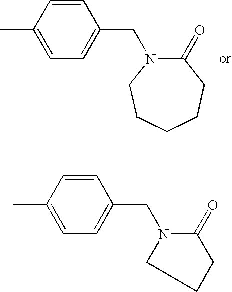
   —C₆H₄CH₂P(O)(OCH₂CH₃)₂
   —C₆H₄CH₂SC(O)CH₃, —C₆H₄CH₂S⁺(CH₂CH₃)2Cl⁻, —C₆H₄CH₂SO₃⁻Na⁺
   —C₆H₄CN, —C₆H₄OH,
   —C₆H₄O—C(O)CH═CH₂, —C₆H₄O—C(O)C(CH₃)═CH₂,
   —C₆H₄OC(O)CH₃, —C₆H₄OC(O)OC(CH)₃,
   —C₆H₄OCH₃, —C₆H₄OCH₂CH₃, —C₆H₄OC(CH₃)₃, —C₆H₄OC₆H₅,
   —C₆H₃(OCH₃)OH, —C₆H₃(OCH₃)₂, —C₆H₃(OCH₃)(OCH₂C₆H₅),
   —CH₂—O13 CO—CH═CH₂ or —CH₂—O—CO—C(CH₃)═CH₂
R₄ —H,
   —CH₂OH
   —CH₂OC(O)H
   —CH₂OC(O)CH₃, CH₂OC(O)C₆H₅,
   —CH₂OCH₃, —CH₂OCH₂CH₃, —CH₂OCH₂CH₂CH₃, —CH₂OCH₂CH₂CH₃,
   —CH₂OCH₂CH₂CH₂CH₃, —CH₂OC₆H₅
   —CH₂O—C(O)CH═CHC(O)OCH₂CH═CH₂,
   —CH₂OC(O)C₆H₄C(O)OCH₂CH═CH₂,
   —CH₂O—C(O)CH═CH₂,
   —CH₂OC(O)C(CH₃)═CH₂,
   —CH₂O(CH₂)₃O—C(O)CH═CH₂,
   —CH₂O(CH₂)₃O—C(O)C(CH₃)═CH₂,
   —CH₂O(CH₂)₃O—C(CH₂)₃OC(O)CH═CH₂,
   —CH₂O(CH₂)₃OC(CH₂)₃O—C(O)C(CH₃)═CH₂,
   —CH₂OCH₂C(CH₂OCH₂CH═CH₂)(CH₂CH₃)CH₂O—C(O)C(CH₃)═CH₂,
   —CH₂CH₂O—C(O)CH═CH₂,
   —CH₂CH₂O—C(O)C(CH₃)═CH₂, 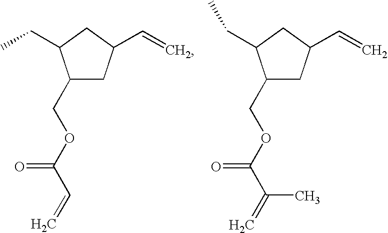
   —CH₂CH₂CH(CH₃)CH₂CH₂O—C(O)C(CH₃)═CH₂,
   —CH₂CH₂CH(CH₃)CH₂CH₂O—C(O)C(CH₂CH₃)═CH₂,
   —C₆H₅, -1-C₁₀H₇, -2C₁₀H₇, —C₁₄H₉,
   —C₆H₄C₆H₅, —C₆H₄CH═CH₂,
   —C₆H₄CH₃, —C₆H₃(CH₃)₂, —C₆H₂(CH₃)₃, —C₆H₁(CH₃)₄, —C₆(CH₃)₅,
   —C₆H₄(CH₂)₇CH₃, —C₆H₄(CH₂)₁₁CH₃, —C₆H₄CH(CH₂)₅, —C₆H₄CH(CH₃)₂, —C₆H₄C(CH₃)₃ —C₆H₄F, —C₆H₄Cl, —C₆H₄Br, —C₆H₄I, —C₆F₄, —C₆H₃F₂, —C₆H₃Cl₂, —C₆H₄Br,
   —C₆H₄CF₃, —C₆H₃(CF₃)₂,
   —C₆H₅, -1-C₁₀H₇, -2-C₁₀H₇, —C₁₄H₉,
   —C₆H₄C₆H₅, —C₆H₄CH═CH₂,
   —C₆H₄CH₃, —C₆H₃(CH₃)₂, —C₆H₂(CH₃)₃, —C₆H₁(CH₃)₄, —C₆(CH₃)₅,
   —C₆H₄(CH₂)₇CH₃, C₆H₄(CH₂)₁₁CH₃, —C₆H₄CH(CH₂)₅, —C₆H₄CH(CH₃)₂, —C₆H₄C(CH₃)₃ —C₆H₄F, —C₆H₄Cl, —C₆H₄Br, —C₆H₄I, —C₆F₄, —C₆H₃F₂, —C₆H₃Cl₂, —C₆H₄Br,
   —C₆H₄CF₃, —C₆H₃(CF₃)₂,
   —C₆H₄CH₂Cl, —C₆H₄CH₂SO₂(CH₂)₂Cl, —C₆H₄CH₂CN,
   —C₆H₄CH₂CH(Si(OCH₂CH₃)₃))CH₃,
   —C₆H₄CH₂OH,
   —C₆H₄CH₂OSi(CH₃)₃, —C₆H₄CH₂OSi(CH₃)₂C(CH₃)₃,
   —C₆H₄CH₂OC(O)CH₃, —C₆H₄CH₂O—C(O)CHCH₂,
   —C₆H₄CH₂O—C(O)C(CH₃)CH₂,
   —C₆H₄CH₂OCH₂CH(O)CH 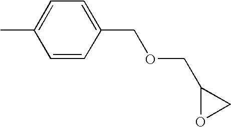
   —C₆H₄CH₂OC(O)CF₃, —C₆H₄CH₂OCH(CF₃)₂, —C₆H₄CH₂O(CF₂)₇CF₃,
   —C₆H₄CH₂N(CH₃)₂, —C₆H₄CH₂N(CH₃)₃⁺Cl⁻, —C₆H₄CH₂NH(CH₂)₃COOH, 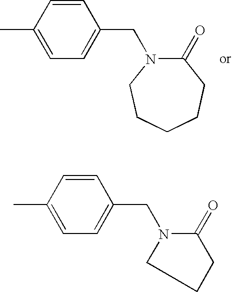
   —C₆H₄CH₂P(O)(OCH₂CH₃)₂
   —C₆H₄CH₂SC(O)CH₃, C₆H₄CH₂S⁺(CH₂CH₃)2Cl⁻, —C₆H₄CH₂SO₃⁻Na⁺
   —C₆H₄CN,
   —C₆H₄OH,
   —C₆H₄O—C(O)CH═CH2, —C₆H₄O—C(O)C(CH₃)═CH₂,
   —C₆H₄OC(O)CH₃, —C₆H₄OC(O)OC(CH)₃,
   —C₆H₄OCH₃, —C₆H₄OCH₂CH₃, —C₆H₄OC(CH₃)₃, —C₆H₄OC₆H₅,
   —C₆H₃(OCH₃)OH, —C₆H₃(OCH₃)₂, —C₆H₃(OCH₃)(OCH₂C₆H₅),
R₅ —H, —CH₃.

Preferably the compounds of the formula Ia-Ie are those wherein
R₁ and R₂ are hydrogen;
R₃ is (meth)acryloyloxy-methyl or phenyl para substituted by vinyl,
R₄ is phenyl or phenyl para substituted by vinyl or (meth)acryloyloxy; or
a substituted phenyl residue of the formula —C₆H₄CH₂—W, wherein W is (meth)acryloyloxy,
or an aliphatic residue of the formula —CH₂—Y-A, wherein
   Y is a bond, O—C₁-C₁₂alkylene, wherein the alkylene linker is linear or branched and may be interrupted once or more than once by oxygen,
   A is hydroxy, C₁-C₆alkoxy, acetoxy, (meth)acryloyloxy, or a phthalate- or maleate-residue;
R₅ is hydrogen
n is 1;
x is —(CH₂)—.

More preferably the compounds of the formula Ia-Ie are those wherein
R₁ and R₂ are hydrogen
R₃ is (meth)acryloyloxy-methyl or phenyl para substituted by vinyl,
R₄ is phenyl or phenyl para substituted by vinyl;
or an aliphatic residue of the formula —CH₂OH, —CH₂-(meth)acryloyloxy, —CH₂-acetoxy or —CH₂—O—C₁-C₁₂alkyl or —CH₂-A, wherein A is a phthalate- or maleate-residue;
R₅ is hydrogen
n is 1;
x is —(CH₂)—.

The diluent may be present in an amount of 5 to 50 wt %, preferably 10 to 30 wt %.

Especially preferred compounds of the formula Ia are

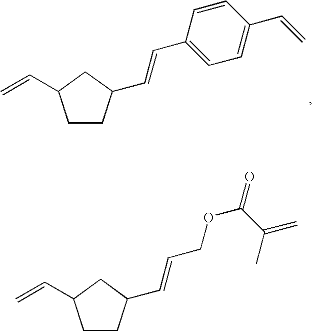

Especially preferred compounds of the formula Ib are the following molecules including their E/Z isomers and regioisomers.

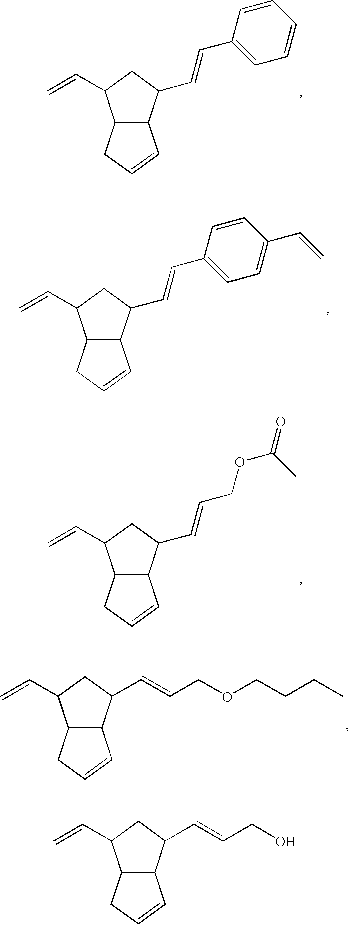

Especially preferred compounds of the formula Id are:

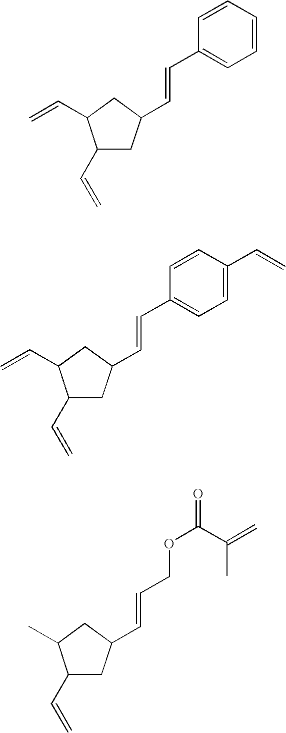

Especially preferred compounds of the formula Ie are: 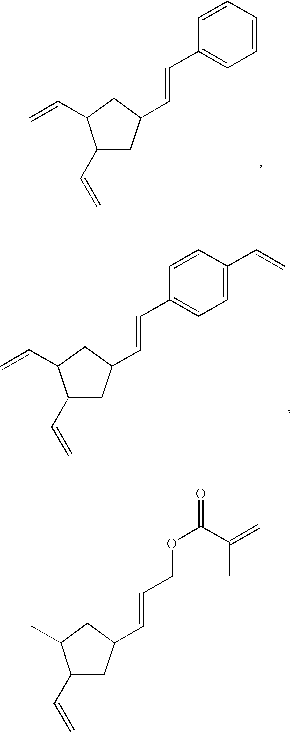
Preferred Embodiment

A coating composition comprising
(1) an alkyd resins,
(2) a reactive diluent of the formula Ia-Ie as defined above or mixtures thereof,
(3) 0.3 to 10 wt. % of a mono-, bis- or trisacylphosphinoxide photoinitiator of the formula 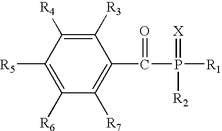
wherein
X is O or S;
R₁ and R₂ independently of one another are linear or branched C₁-C₁₂-alkyl, C₁-C₁₂-alkoxy, phenyl, unsubstituted or optionally substituted by OR₉, SR₉, NR₁₀R₁₁, C₁-C₁₂-Alkyl or halogen; or

R₁ and R₂ are phenyl-C₁-C₄alkyl or 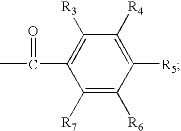
R₃ and R₇ independently of one another are C₁-C₁₂-alkyl, C₁-C₁₂-alkoxy or halogen;
R₄, R₅ and R₆ independently of one another are hydrogen, C₁-C₁₂-alkyl, C₁-C₁₂-alkoxy or halogen;
R₈, R₉ R₁₀ and R₁₁ independently of one another are hydrogen, C₁-C₁₂-alkyl, C₂C₁₂-alkenyl, benzyl or C₂C₂₀-alkyl interrupted once or several times by —O—; or R₁₀ and R₁₁ represent together with the N-atom that they are attached to an optionally oxygen or —NR₁₂-containing 5 or 6 membered ring;
R₁₂ is hydrogen, phenyl-C₁-C₄-alkyl or C₁-C₁₂-alkyl.

It is also possible to use mixtures with other known reactive diluents.

Especially suitable is Irgacure 819 (bis(2,4,6-trimethylbenzoyl)-phenylphosphine oxide).

Additives

The coating composition according to the invention may furthermore contain various additives such as UV stabilizers, cosolvents, dispersants, surfactants, inhibitors, fillers, anti-static static agents, flame-retardant agents, lubricants, antifoaming agents, extenders, plasticizers, anti-oxidants, anti-freezing agents, waxes, thickeners, thixotropic agents, etc. The composition may be used as a clear varnish or may contain pigments. Examples of pigments suitable for use are metal oxides, such as titanium dioxide or iron oxide, or other inorganic or organic pigments.

The coating composition according to the present invention can be applied by conventional methods, including brushing, roll coating, spray coating, or dipping.

Preparation

The compounds of formula Ia-Ie can be prepared starting from the following cycloolefins Ia′-Ie′

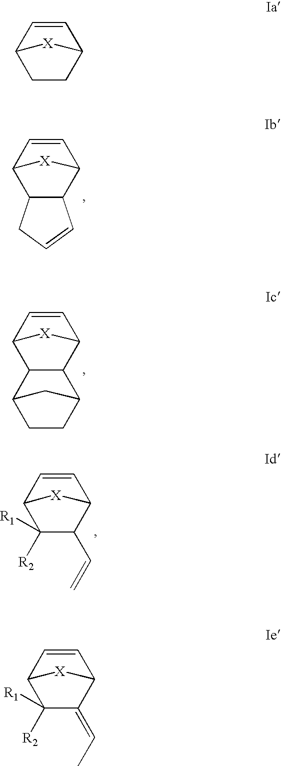

The above cyclo-olefins are reacted in the presence of a metathesis catalyst with a terminal olefin of the formula 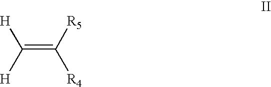
X, R₁, R₂, R₄, R₅ are as defined above.

The cyclo-olefins can be prepared by Diels-Alder reactions analogue to the case described for example in WO97/32913.

The following cycloolefins are commercially available.

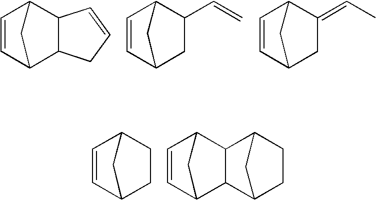

Suitable metathesis catalyst are ruthenium, molybdenum or osmium metal carbene complex as for example described in EP0885911A1, EP0839821A2, EP0808338B1, WO93/20111, WO95/07310, WO96/16101, WO97/14738A1, WO97/31913, WO97/38036A1, WO97/32913, WO98/39346A1, WO99/29701 A1, WO99/00397A1 and WO99/00396A1.

Preferred are ruthenium carbenes of the formula (X) with two phosphine ligands and two halogen atoms such as disclosed in WO97/32913. 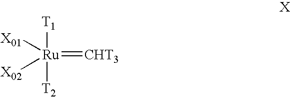
wherein
T₁ and T₂ independently of one another are tertiary phosphines, or T₁ and T₂ together are a tertiary diphosphine;
T₃ is H, C₁-C₁₂alkyl, C₃-C₆cycloalkyl, C₃-C₇heterocycloalkyl with one or two heteroatoms selected from the group consisting of —O—, —S— and —N—; C₆-C₁₄ aryl, or C₄-C₁₅ heteroaryl with one to three heteroatoms selected from the group consisting of —O—, —S— and —N— which are unsubsituted or substituted by C₁-C₁₂ alkyl, C₁-C₁₂haloalkyl, C₁-C₁₂ alkoxy, C₆-C₁₀aryl, C₆-C₁₀aryloxy, NO₂ or halogen;
X₀₁ and X₀₂ independently of one another are halogen.

Some specific examples are:
Cl₂[P(C₆H₁₁)₃]₂Me=CH—C₆H₅, Cl₂[P(C₅H₉)₃]₂Me=CH—C6H₅, Br₂[P(C₆H₁₁)₃]₂Me=CH—C₆H₅,
Br₂[P(C₅H₉)₃]2Me=CH—C₆H₅, F₂[P(C₆H₁₁)₃]₂Me=CH—C₆H₅, F₂[P(C₅H₉)₃]₂Me=CH—C₆H₅,
Cl₂[P(C₆H₁₁)₃]₂Me=CH(C₆H₄—Cl), Cl₂[P(C₅H₉)₃]₂Me=CH(C₆H₄—Br),
Br₂[P(C₆H₁₁)₃]₂Me=CH(C₆H₄—NO₂), Br₂[P(C₅H₉)₃]₂Me=CH(C₆H₄—OC₂H₅),
Cl₂[P(C₈H₁₁)₃]₂Me=CH(C₆H₄—CH₃), F₂[P(C₅H₉)₃]₂Me=CH[C₆H₃—(CH₃)₂],
Cl₂[P(C₆H₁₁)₃]₂Me=CH—C₁₀H₉, Cl₂[P(C₅H₉)₃]₂Me=CH—CH₃, Cl₂[P(C₆H₁₁)₃]₂Me=CHCH₃,
Br₂[P(C₅H₉)₃]₂Me=CH-i-C₃H₇, Cl₂[P(C₆H₁₁)₃]₂Me=CH-t-C₄H₉, Cl₂[P(C₅H₉)₃]₂Me=CH-n-C₄H₉,
Cl₂[P(C₆H₁₁)₃]₂Me=CH—C₆H₄—OCH₃, Cl₂[P(C₅H₉)₃]₂Me=CH—C₆H₃—(CH₃)₂,
Br₂[P(C₆H₁₁)₃]₂Me=CH—C₆H₂—(CH₃)₃, Br₂[P(C₅H₉)₃]₂Me=CH—CH₂C₆H₅,
Cl₂[P(t-C₄H₉)₃]₂Me=CH—C₆H₅, Cl₂ [P(i-C₃H₇)₃]₂Me=CH—C₆H₅, Cl₂[P(C₈H₅)₃]₂Me=CH—C₆H₅,
Cl₂[P(C₆H₃—CH₃)₃]₂Me=CH—C₆H₅, Br₂[P(C₅H₄(CH₃)₂)₃]₂Me=CH—C₆H₅,
Cl₂[(C₆H₃—(CH₃)₃]₂Me=CH—C₆H₅, Cl₂[P(C₆H₁₁)₃—CH₂CH₂—P(C₆H₁₁)₃]Me=CH—C₆H₅,
Cl₂[P(C₅H₉)₃]₂Me=CH—C₆H₁₁, Cl₂[P(C₅H₉)₃]₂Me=CH—C₅H₉, C12[P(C₅H₉)₃]₂Me=C(C₆H₁₁)₂,
Cl₂[P(C₆H₁₁)₃]₂Me=CH₂, Cl₂[P(C₅H₉)₃]₂Me=CH₂, Cl₂[P(C₆H₁₁)₃]₂Me=CH-nbutyl,
Cl₂[P(C₃H₇)₃]₂Me=CH—C₆H₅, C12[P(C₃H₇)₃]₂Me=CH—C₆H₁₁, Cl₂[P(i-C₃H₇)₃]₂Me=CH—C₆H₅,
Cl₂[P(i-C₃H₇)₃]₂Me=CH—C₅H₁₁.

Also preferred are catalysts as described in WO99/29701 such as, for example,

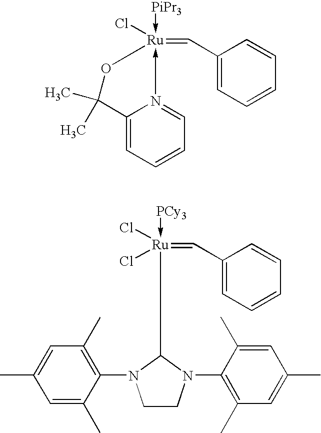

The choice of the catalyst is not critical.

Especially preferred is bis-(tricyclohexylphosphin)benzyliden ruthenium-(IV)-dichloride Cl₂[P(C₆H₁₁)₃]₂Me=CH—C₆H₅.

Also preferred is Cl₂[P(C₃H₇)₃]₂Me=CHS—C₆H₅.

The metathesis catalyst is used in an amount of 0.005 wt % up to 5 wt %, preferably 0.05 to 0.2 wt %. The Ru-catalyst is removed by absorption on a polar support. After distillation of the volatile reaction by-products, the product of formula I is obtained without any further purification.

Advantageous

The inventive diluents of the formula Ia-Ie can be prepared in one step using ring opening metathesis polymerization. Thus, multifunctional products can be obtained, having a high double bond density, depending on the choice of the reaction parameters.

When using the inventive diluents, it is possible to replace the siccatives by photoinitiators. The inventive coating compositions are storage stable under exclusion of light. Polymerisation occurs only when the compositions are exposed to light. The inventive coating compositions are tack-free after standard radiation curing.

Use

The inventive compositions are especially suitable for use as a decorative or do-it-yourself coating, e.g. for wood substrates, such as door or window frames, but can also be used in industry, in particular for wooden substrates. The coating composition may also be used for substrates made of metal, concrete, plastic materials or other materials.

Furthermore the coatings may be used in sheetfed offset printing inks. These inks preferably contain resin mixtures including alkyd resins. Suitable resin mixtures are: Terlon 3, Sparkl 609, Luminex 11.

### EXPERIMENTALS

### Example 1

### 2-Methyl-acrylic Acid 3-(3-vinyl-1,2,3,3a,4,6a-hexahydro-pentalen-1-yl)-allyl Ester

Compound of formula Ib with R₄═CH₂—Y-A, Y=bond, A is methacryloyloxy.

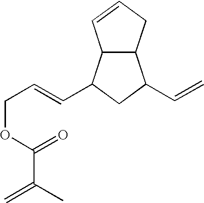

A three-neck flask equipped with magnetic stirrer, thermometer and a reflux condenser and equipped for nitrogen flow is flushed with nitrogen. The flask is charged with (19.8 g, 0.15 mol) dicyclopentadiene and with (113.5 g, 0.90 mol) allylmethacrylate. The solution is stirred under nitrogen at room temperature followed by the addition of a solution of 0.5 mol % of bis(tricyclohexylphosphin)benzylidene ruthenium-(IV)-dichloride dissolved in 1.5 ml dichloromethane.

After the exothermic reaction is over, the flask is allowed to cool until reaching room temperature and stirring is carried out for a further 2 hours at room temperature. The progress of the reaction is controlled by gas-chromatography (GC). 200 ml hexane and 15 g bleaching earth (Tonsil AC) are added to the reaction mixture. Stirring is carried out for a further 15 minutes and the solid is filtered off. After evaporation of hexane and surplus allylmethacrylate under vacuum, a colorless oil is obtained (37.7 g, 90% of theory) which, after characterization by ¹H-NMR, proves to be the desired compound as major compound. In order to stabilize the oil 1000 ppm HQM (hydroquinone monomethylether) is added.

### Example 2

### Acetic Acid 3-(3-vinyl-1,2,3,3a,4,6a-hexahydro-pentalen-1-yl)-allyl Ester

Compound of formula Ib with R₄═CH₂—Y-A, Y=bond, A is acetoxy.

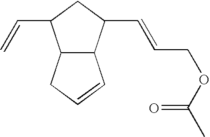

Acetic acid 3-(3-vinyl-1,2,3,3a,4,6a-hexahydro-pentalen-1-yl)-allyl ester is prepared according to Example 1 using 6.6 g, 0.05 mol dicyclopentadiene and 30.0 g, 0.30 mol allylacetate in the presence of 0.3 mol % bis-(tricyclohexylphosphin)benzylidene ruthenium-(IV)-dichloride. 11.0 g of a low-viscous oil is obtained (99% of theory) which, after characterization by ¹H-NMR, contains the reactive diluent as major compound.

### Example 3

### 3-(3-Vinyl-1,2,3,3a,4,6a-hexahydro-pentalen-1-yl)-prop-2-en-1-ol

Compound of formula Ib with R₄═CH₂—Y-A, Y=bond, A is hydroxy 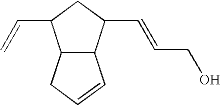
3-(3-Vinyl-1,2,3,3a,4,6a-hexahydro-pentalen-1-yl)-prop-2-en-1-ol is prepared according to Example 1 using 6.75 g, 0.051 mol dicyclopentadiene and 17.79 g, 0.30 mol allylalcohol in the presence of 0.3 mol % bis-(tricyclohexylphosphin)benzylidene ruthenium-(IV)-dichloride. 6.34 g of an oil is obtained. After distillation under high vacuum in a ball-tube oven 5.15 g (53%) of a colorless oil is obtained which, after characterization by ¹H-NMR, contains the reactive diluent as major compound.

### Example 4

### 1-(3-Butoxy-propenyl)-3-vinyl-1,2,3,3a,4,6a-hexahydro-pentalene

Compound of formula Ib with R₄═CH₂—Y-A, Y is a bond, A is alkoxy 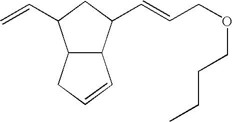
1-(3-Butoxy-propenyl)-3-vinyl-1,2,3,3a,4,6a-hexahydro-pentalene is prepared according to Example 1 using 10.7 g, 0.081 mol dicyclopentadiene and 9.2 g, 0.81 mol allylbutylether in the presence of 0.1 mol % bis-(tricyclohexylphosphin)benzylidene ruthenium-(IV)-dichloride. 9.8 g of a colorless oil is obtained (49% of theory) which, after characterization by ¹H-NMR, contains the reactive diluent as major compound.

### Example 5

### But-2-enedioic Acid Allyl Ester 3-(3-vinyl-1,2,3,3a,4,6a-hexahydro-pentalen-1-yl)-allyl Ester

Compound of formula Ib with R₄═CH₂—Y-A, Y is a bond, A is a maleate residue. 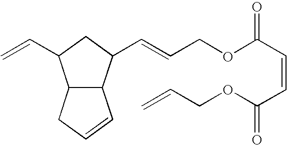
But-2-enedioic acid allyl ester 3-(3-vinyl-1,2,3,3a,4,6a-hexahydro-pentalen-1-yl)-allyl ester is prepared according to Example 1 using 13.2 g, 0.10 mol dicyclopentadiene and 19.6 g, 0.10 mol diallylmaleaet in the presence of 0.1 mol % bis-(tricyclohexylphosphin)benzylidene ruthenium-(IV)-dichloride. 27.8 g (85% of theory) of a light brown oil is obtained which, after characterization by ¹H-NMR, contains the reactive diluent as major compound.

### Example 6

### Phthalic Acid 1-allyl Ester 2-[3-(3-vinyl-1,2,3,3a,4,6a-hexahydro-pentalen-1-yl)-allyl] Ester

Compound of formula Ib with R₄═CH₂—Y-A, Y is a bond, A is a phthalate residue 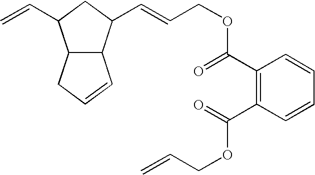
Phthalic acid 1-allyl ester 2-[3-(3-vinyl-1,2,3,3a,4,6a-hexahydro-pentalen-1-yl)-allyl]ester is prepared according to Example 1 using 13.2 g, 0.10 mol dicyclopentadiene and 24.6 g, 0.10 mol diallylphthalate in the presence of 0.1 mol % bis-(tricyclohexylphosphin)benzylidene ruthenium-(IV)-dichloride. 35.8 g (95% of theory) of a light brown oil is obtained which, after characterization by ¹H-NMR, contains the reactive diluent as major compound.

### Example 7

### 1-Styryl-3-vinyl-1,2,3,3a,4,6a-hexahydro-pentalene

Compound of formula Ib with R₄=phenyl. 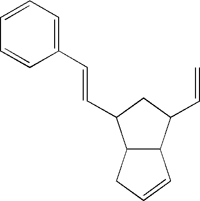
1-Styryl-3-vinyl-1,2,3,3a,4,6a-hexahydro-pentalene is prepared according to Example 1 using 5.6 g, 0.042 mol dicyclopentadiene and 13.2 g, 0.12 mol styrene in the presence of 0.3 mol % bis-(tricyclohexylphosphin)benzylidene ruthenium-(IV)-dichloride. 7.9 g (79% of theory) of a colorless oil is obtained which, after characterization by ¹H-NMR, contains the reactive diluent as major compound.

### Example 8

### 3-Vinyl-1-[2-(4-vinyl-phenyl)-vinyl]-1,2,3,3a,4,6a-hexahydro-pentalene

Compound of formula Ib with R₄ is phenyl para substituted by vinyl. 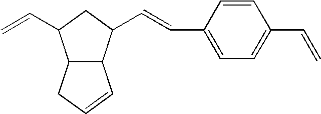
3-Vinyl-1-[2-(4-vinyl-phenyl)-vinyl]-1,2,3,3a,4,6a-hexahydro-pentalene is prepared according to Example 1 using 6.6 g, 0.05 mol dicyclopentadiene and 19.5 g, 0.15 mol divinylbenzene in the presence of 0.05 mol % bis-(tricyclohexylphosphin)benzylidene ruthenium-(IV)-dichloride. 11.7 g (89% of theory) of a colorless oil is obtained which, after characterization by ¹H-NMR, contains the reactive diluent as major compound.

1000 ppm Irganox 1520 are added for stabilisation.

### Example 9

### 1-Vinyl-4-[2-(3-vinyl-cyclopentyl)-vinyl]-benzene

Compound of the formula Ia with R₃=phenyl para sunstituted by vinyl. 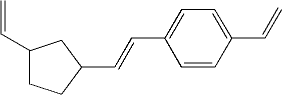
1-Vinyl-4-[2-(3-vinyl-cyclopentyl)-vinyl]benzene is prepared according to Example 8 using norbornene and divinylbenzene.

Products with n=2 are for example:

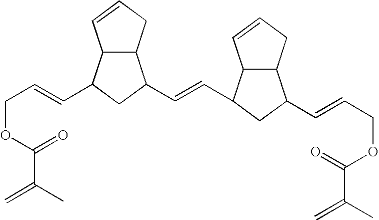

### APPLICATION EXAMPLES

1. Coating Compositions:

| Formulation I | Comparative | A |
|---|---|---|
| Ingredients | % | % |
| Jagol PS 21 (Ernst Jäger) alkyd resin | 73.80 | 73.80 |
| Exsol D 40 (aliphatic hydrocarbon), solvent | 21.19 | — |
| Exkin 2 (methylethylketoxim), anti skinning | 0.52 | — |
| Octa-Soligen Calcium 10 (Borchers GmbH) drier | 0.25 | — |
| Octa-Soligen Zirkonium 6 (Borchers GmbH) | 2.33 | — |
| Octa-Soligen Cobalt 6 (Borchers GmbH) | 0.62 | — |
| Octa-Soligen Zink 6 (Borchers GmbH) | 0.57 | — |
| Lanco Glidd AH (Lubrizol Coating Additives) | 0.72 | 0.72 |
| IRGACURE 819 photoinitiator | — | 2.0 |
| reactive diluent | — | 21.19 |
| Σ | 100.0 | 100.0 |

IRGACURE 819: Bis(2,4,6-trimethylbenzoyl)-phenylphosphineoxide

| Formulation II | comparative | A |
|---|---|---|
| Ingredients | % | % |
| Worléekyd B870, 75% (Worlée Chemie); alkyd | 80.0 | 80.0 |
| Varsol D30 (aliphatic hydrocarbon) solvent | 17.5 | — |
| Exkin 2 (methylethylketoxim) | 0.5 | — |
| Octa-Soligen Calcium 10 (Borchers GmbH) | 1.0 | — |
| Octa-Soligen Zirkonium 6 (Borchers GmbH) | 0.6 | — |
| Octa-Soligen Cobalt 6 (Borchers GmbH) | 0.4 | — |
| Irgacure 819 | — | 2.0 |
| Reactive diluent | — | 17.5 |
| Σ | 100.0 | 100.0 |

For evaluation of the drying behavior the above coatings are applied with a 76 μm slit coater to glass and the measurement with the BK-Recorder is started under different light sources at once. A needle is put on the wet film and is pushed with a constant speed of 28 cm/6 h through the film. The record shows five different phases of the drying process within the first 6 hours after application. For evaluation the end of the phases 1 to 4 are listed.

PICTURE 1
Different phases of the BK-Recorder measurement.

| | |
|---|---|
| Phase 1 | No remaining line (wet film) |
| Phase 2 | Smooth remaining line (increased viscosity of the coating) |
| Phase 3 | Fringed line (gelation) |
| Phase 4 | Interrupted line or surface marks (crosslinking) |
| Phase 5 | No visible marks |
| 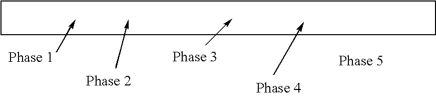 | |

The pendulum hardness is determined at 100 μm on glass plates.

As light sources two fluorescent lamps TL 20 W/03 (Philips; distance: 27 cm), common fluorescent daylight lamps (Hanau 001660 40 W) and diffuse indoor daylight are used.

The viscosity of the formulations is determined by ICI plate-plate viscometer after preparation and different storage time.

Drying Behaviour

Tables 1 and 2 show the drying behavior of the above alkyd systems upon exposure to fluorescent and daylight lamps. The values are given in min.

TABLE 1
Formulation I

| | TL03/20 W-lamp | | | | Daylight lamp | | | |
|---|---|---|---|---|---|---|---|---|
| | phase | | | | phase | | | |
| | 1 | 2 | 3 | 4 | 1 | 2 | 3 | 4 |
| Comparative | 48 | 58 | 77 | 113 | 68 | 85 | 98 | 184 |
| A: diluent Ex. 1 | 4 | 8 | 31 | 60 | 19 | 28 | 144 | 180 |

TABLE 2
Formulation II

| | TL03/20 W-lamp | | | | Daylight lamp | | | |
|---|---|---|---|---|---|---|---|---|
| | phase | | | | phase | | | |
| | 1 | 2 | 3 | 4 | 1 | 2 | 3 | 4 |
| Comparative | 81 | 109 | 150 | 216 | 45 | 141 | 183 | 226 |
| A: diluent | 17 | 31 | 67 | 202 | 32 | 49 | 77 | 159 |
| accord. to Ex. 8 | | | | | | | | |
| A: diluent | 6 | 10 | 57 | 90 | 19 | 31 | 81 | 231 |
| accord. to Ex. 1 | | | | | | | | |

Pendulum Hardness

Tab. 3 shows the pendulum hardness upon fluorescent lamps and indoor daylight exposure in the Formulation II.

The use of the reactive diluents and photoinitiator IRGACURE 819 causes a significant increase of the pendulum hardness after one week. The storage stability is good.

TABLE 3

pendulum hardness (s)
after 168 hours

| | TL03/20 W-lamp | Daylight |
|---|---|---|
| Comparative Formulation II | 33 | 21 |
| A: diluent accord. to Ex. 8 | 75 | 57 |
| A: diluent accord. to Ex. 1 | 84 | 50 |

Comparison of the Reactive Diluents in Formulation II

The formulation containing a diluent according to the invention shows a slightly improved drying behavior. Diallylfumarate, Diethylfumarate and Diallylmaleate do not lead to an increase of the pendulum hardness compared to formulation containing a diluent according to the invention.

TABLE 4
drying behavior of formulation II upon daylight lamps.
values given in min.

| | phase 1 | phase 2 | phase 3 | phase 4 |
|---|---|---|---|---|
| Comparative | 42 | 160 | 188 | 254 |
| Example 1 | 32 | 54 | 98 | 158 |
| Diethylfumarate | 36 | 56 | 77 | 102 |
| Diallylmaleate | 58 | 68 | 84 | 110 |
| Diallylfumarate | 60 | 74 | 89 | 113 |

TABLE 5
pendulum hardness after exposure to indoor
daylight and initial viscosity in Formulation II

| | |
|---|---|
| Pendulum | |
| hardness (s) | Viscosity (P) |

| | | | |
|---|---|---|---|
| Exposure time (h) | 330 | 500 | 0 |
| Comparative | 23 | 25 | 5.1 |
| Example 1 | 70 | 84 | 7.8 |
| Diethylfumarate | 17 | 18 | 4.4 |
| Diallylmaleate | 15 | 15 | 4.2 |
| Diallylfumarate | 14 | 15 | 4.4 |

### ALTERNATIVE EMBODIMENT

Using mono- or bisacylphosphinoxides as photoinitiators, it has been found that the alkyd coating composition can be cured without any reactive diluent.

Thus, the invention further relates to a coating composition based on an alkyd resin comprising Mapo/Bapo photoinitiators.

In the US-Publication 20020026049 it is stated that Mapo photoinitiators may be suitable as initiators for the curing of oxidatively drying systems without specifying the system. There is no hint to solvent based or water based alkyd coating systems.

It has been found that the siccative and the antiskinning agent can be replaced by using mono-bis- or trisacylphosphinoxides as photoinitiators, thus obtaining a metal free, especially cobalt free and methyl ethyl ketoxime (MEKO) free coating composition.

Cobalt dust and MEKO are both considered to be cancer suspect agents.

Thus, the invention relates to a solvent based or water based alkyd coating composition comprising 0.3 to 10 wt. % of a mono-, bis- or trisacylphosphinoxide photoinitiator of the formula I 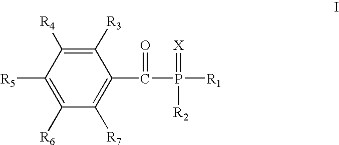
as describes above.

Preferred are compounds of the formula I′ as describesd above.

Especially preferred are compounds of the formula I′ as described above.

Most preferred is bis(2,4,6-trimethylbenzoyl)phenylphosphine oxide.

The invention further relates to the use of a mono-, bis- or trisacylphosphinoxide photoinitiator to cure siccative free and/or anti-skinning agent free alkyd resins.

The invention further relates to a process for curing a solvent based or water based alkyd resin by photochemical treatment with light of a wavelength from 200 to 600 nm.

Definitions and Preferences

Alkyd Resin

Alkyd resins are those as described above.

Solvent

Solvents are aliphatic, cycloaliphatic and aromatic hydrocarbons such as mineral spirits known as white spirit, as well as xylene, toluene, alcohol ethers, glycol ethers, ketones, esters, alcohol ether acetates or mixtures thereof.

As non limiting examples of such solvents may be mentioned toluene, xylene, hydrocarbon solvents available under the trademarks Exsol and Varsol from Exxon Chemicals Co., and solvents such as ethyl acetate, butylacetate, ethyl diglycol, ethyl glycol acetate, butyl glycol, butyl glycol acetate, butyl diglycol, butyl diglycol acetate, and methoxypropylene glycol acetate. Mixtures of solvents may also be used.

Photoinitiators:

Suitable bisacylphosphine oxides and their preparation by oxidation of the corresponding bisacylphosphines are described in EP-B184095 or U.S. Pat. No. 4,737,593.

Preferred bisacylphosphinoxides are those described in U.S. Pat. No. 5,534,559. and listed above.

Especially preferred photoinitiators are:

Monoacylphosphine oxides such as, for example, Lucirin TPO (commercially available from BASF) or
[Benzyl-(4-morpholin-4-yl-phenyl)-phosphinoyl]-(2,4,6-trimethylphenyl)-methanone 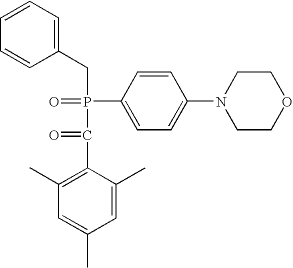
   which can be prepared according to the PCT Application PCT-EP02/09045 filed Aug. 13, 2002, or
[(2-Ethylhexyl)-(2,4,4-trimethyl-pentyl)-phosphinoyl]-(2,4,6-trimethyl-phenyl)-methanone 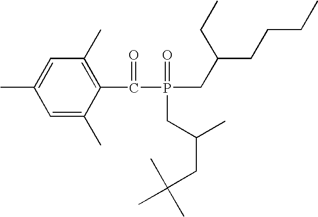
   which can be prepared according to US-Publication 20020026049 corresponding to the British patent publication GB2365430; or
   2,4,6-trimethylbenzoyl-phenyl phosphinic acid ethyl ester (BASF).

Bisacylphoshine oxides such as, for example, 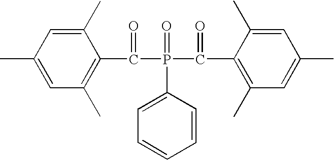
Irgacure 819, commercially available from Ciba.

It is also possible to use

Acylphosphine sulfides such as, for example,
[phenyl-(2,4,6-trimethyl-benzoyl)-phosphinothioyl]-(2,4,6-trimethylphenyl)-methanone 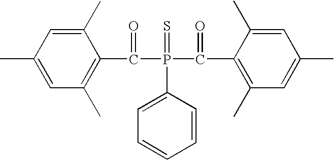
   which can be prepared according to U.S. Pat. No. 5,368,985,
   or 9-(2,4,6-trimethylbenzoyl)-9-phosphabicyclo[3.3.1]nonane-9-sulfide, 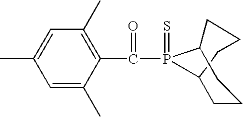
   which can be prepared according to U.S. Pat. No. 5,399,782.

Especially preferred are bisacylphosphine oxides, for example Irgacure 819 or its dispersion in water (Irgacure 819DW).

Typical amounts of the photoinitiator can be, for example, about 0.3 wt. % to about 10 wt. %, and preferably, about 1 wt. % to about 5 wt. %.

Additives

The coating composition according to the Invention may furthermore contain various additives as described above.

Coating compositions according to the invention can be used for coating precoated or uncoated substrates of wood, metal, plastics, ceramics, concrete, etc.

The coating composition according to the present invention can be applied by conventional methods, including brushing, roll coating, spray coating, or dipping.

### APPLICATION EXAMPLES

1. Coating Compositions:

| Formulation I | Comparative | B |
|---|---|---|
| Ingredients | % | % |
| Jagol PS 21 (Ernst Jäger) alkyd resin | 73.80 | 73.80 |
| Exsol D 40 (aliphatic hydrocarbon), solvent | 21.19 | 21.19 |
| Exkin 2 (methylethylketoxim), anti skinning | 0.52 | — |
| Octa-Soligen Calcium 10 (Borchers GmbH) drier | 0.25 | — |
| Octa-Soligen Zirkonium 6 (Borchers GmbH) | 2.33 | — |
| Octa-Soligen Cobalt 6 (Borchers GmbH) | 0.62 | — |
| Octa-Soligen Zink 6 (Borchers GmbH) | 0.57 | — |
| Lanco Glidd AH (Lubrizol Coating Additives) | 0.72 | 0.72 |
| IRGACURE 819 photoinitiator | — | 2.0 |
| Σ | 100.0 | 100.00 |

IRGACURE 819: Bis(2,4,6-trimethylbenzoyl)-phenylphosphineoxide

| Formulation II | comparative | A |
|---|---|---|
| Ingredients | % | % |
| Worléekyd B870, 75% (Worlée Chemie); alkyd | 80.0 | 80.0 |
| Varsol D30 (aliphatic hydrocarbon) solvent | 17.5 | 17.5 |
| Exkin 2 (methylethylketoxim) | 0.5 | — |
| Octa-Soligen Calcium 10 (Borchers GmbH) | 1.0 | — |
| Octa-Soligen Zirkonium 6 (Borchers GmbH) | 0.6 | — |
| Octa-Soligen Cobalt 6 (Borchers GmbH) | 0.4 | — |
| Irgacure 819 | — | 2.0 |
| Σ | 100.0 | 100.0 |

For evaluation of the drying behavior the above coatings are applied with a 76 μm slit coater to glass and the measurement with the BK-Recorder is started under different light sources at once. A needle is put on the wet film and is pushed with a constant speed of 28 cm/6 h through the film. The record shows five different phases of the drying process within the first 6 hours after application. For evaluation the end of the phases 1 to 4 are listed.

PICTURE 1
Different phases of the BK-Recorder measurement.

| | |
|---|---|
| Phase 1 | No remaining line (wet film) |
| Phase 2 | Smooth remaining line (increased viscosity of the coating) |
| Phase 3 | Fringed line (gelation) |
| Phase 4 | Interrupted line or surface marks (crosslinking) |
| Phase 5 | No visible marks |
| 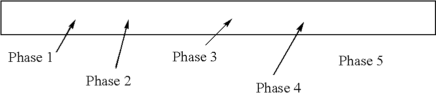 | |

Drying Behaviour

Tables 1 and 2 show the drying behavior of the above alkyd systems upon exposure to fluorescent and daylight lamps. The values are given in min.

TABLE 1
Formulation I

| | TL03/20 W-lamp | | | | Daylight lamp | | | |
|---|---|---|---|---|---|---|---|---|
| | phase | | | | phase | | | |
| | 1 | 2 | 3 | 4 | 1 | 2 | 3 | 4 |
| Comparative | 48 | 58 | 77 | 113 | 68 | 85 | 98 | 184 |
| B | 8 | 13 | 49 | 171 | 32 | 45 | 129 | 141 |

TABLE 2
Formulation II

| | TL03/20 W-lamp | | | | Daylight lamp | | | |
|---|---|---|---|---|---|---|---|---|
| | phase | | | | phase | | | |
| | 1 | 2 | 3 | 4 | 1 | 2 | 3 | 4 |
| Comparative | 81 | 109 | 150 | 216 | 45 | 141 | 183 | 226 |
| B | 6 | 13 | 23 | 48 | 31 | 44 | 75 | 107 |

1. Compounds of the formula Ia-Ie 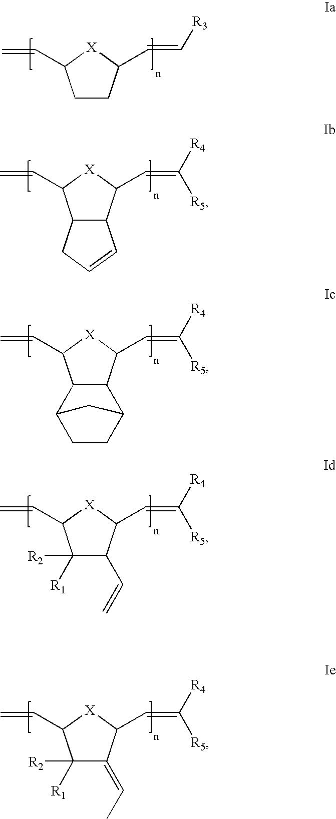
wherein
R₁ and R₂ independently of one another are hydrogen, hydroxy, cyano, halogen, vinyl, formyl, a residue of acrylic acid, C₁-C₆alkoxycarbonyl, C₁-C₆alkylaminocarbonyl, phenylcarbonyl, C₁-C₆alkylcarbonyloxy, C₁-C₆alkenylcarbonyloxy, (meth)acryloyloxy, (meth)acryloylC₁-C₆alkyl amino, di[(meth)acryloylC₁-C₆alkyl]amino, unsubstituted C₁-C₁₂alkyl or C₁-C₁₂alkyl substituted by hydroxy, halogen, ethynyl, C₁-C₆alkylamino, di(C₁-C₆)alkylamino, (meth)acryloyloxy, (meth)acryloylC₁-C₆alkylamino, di[(meth)acryloylC₁-C₆alkyl]amino or by tolylaminocarbonyloxy;
R₃ is (meth)acryloyloxy-C₁-C₆alkyl or phenyl substituted once or more than once by hydroxy, halogen, cyano, vinyl, C₁-C₁₂alkyl, C₁-C₆alkoxy, phenoxy, benzyloxy, acetoxy, C₁-C₆alkoxycarbonyloxy, C₁-C₆alkylcarbonyloxy, trifluoromethyl, (meth)acryloyloxy, (meth)acryloyl C₁-C₆alkylamino, di[(meth)acryloylC₁-C₆alkyl]amino; or R₃ is 1-naphthyl, 2-naphthyl, biphenyl, anthracenyl; or R₃ is a substituted phenyl residue of the formula C₆H₄CH₂—W, wherein W signifies hydroxy, halogen, cyano, acetoxy, acetylsulfanyl, trifluoromethylcarbonyloxy, (meth)acryloyloxy, (meth)acryloylC₁-C₆alkylamino, di[(meth)acryloylC₁-C₆alkyl]amino, C₁-C₁₂alkoxy, C₁-C₁₂alkoxy substituted once or more than once by fluorine, C₁-C₁₂alkoxy substituted by epoxyethyl; or W is dimethylamino, dimethylammonium, or W is a residue selected from an amino butyric acid or from an an ε-caprolactame, or W is sulfonato, C₁-C₆alkylsulfonyl or C₁-C₆alkylsulfanyl, wherein the alkyl group is unsubstituted or substituted by chlorine; or W is a silanol residue or a residue of a phosphonic acid;
R₄ is hydrogen, phenyl, 1-naphthyl, 2-naphthyl, biphenyl, anthracenyl, phenyl substituted once or more than once by hydroxy, halogen, cyano, vinyl, C₁-C₁₂alkyl, C₁-C₆alkoxy, phenoxy, benzyloxy, acetoxy, C₁-C₆alkoxycarbonyloxy, C₁-C₆alkylcarbonyloxy, trifluoromethyl, (meth)acryloyloxy, (meth)acryloylC₁-C₆alkylamino, di[(meth)acryloylC₁-C₆alkyl]amino, or R₄ is a substituted phenyl residue of the formula —C₆H₄—CH₂—W, wherein W signifies hydroxy, halogen, cyano, acetoxy, acetylsulfanyl, trifluoromethylcarbonyloxy, (meth)acryloyloxy, (meth)acryloylC₁-C₆alkylamino, di[(meth)acryloylC₁-C₆alkyl]amino, C₁-C₁₂alkoxy, C₁-C₁₂alkoxy substituted once or more than once by fluorine, C₁-C₁₂alkoxy substituted by epoxyethyl; or W is dimethylamino, dimethylammonium, or W is a residue selected from an amino butyric acid or from an an ε-caprolactame, or W is sulfonato, C₁-C₆alkylsulfonyl or C₁-C₆alkylsulfanyl, wherein the alkyl group is unsubstituted or substituted by chlorine; or W is a silanol residue or a residue of a phosphonic acid; or
R₄ is an aliphatic residue of the formula —(CR₆R₇)ₘY-A, wherein
R₆ and R₇ independently of one another are hydrogen, C₁-C₁₂alkyl or phenyl;
m is 1-10,
Y is a bond, O—C₁-C₁₂alkylene, wherein the alkylene linker is linear or branched and may be interrupted once or more than once by oxygen,
A is hydroxy, C₁-C₆alkoxy, phenoxy, phenylcarbonyloxy, formyloxy, acetoxy, benzoyloxy, (meth)acryloyloxy, (meth)acryloyl-C₁-C₆alkylamino, di[(meth)acryloylC₁-C₆alkyl]amino; or a phthalate or maleate-residue; or
R₄ is a residue of the formula A or B 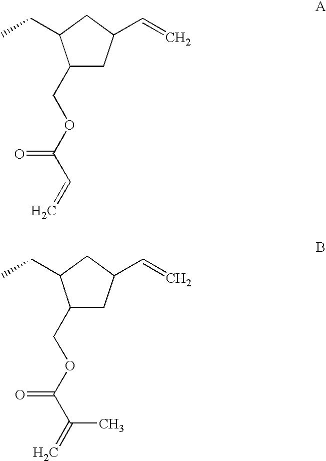
R₅ is hydrogen or C₁-C₆alkyl;
n is a number of 1-10;
X is —(CH₂)₁₋₄—, CR₈R₉—, —CO—, —O—, —NR₁₀—, —S—,
R₈ and R₉ independently of one another are hydrogen, unsubstituted C₁-C₆-alkyl or C₁-C₆-alkoxy, C₁-C₆-alkyl substituted by OH, C₁-C₆-alkoxy or halogen; unsubstituted aryl or aryl substituted by C₁-C₄-alkyl, OH, C₁-C₆alkoxy or halogen; or C₁-C₆alkylcarbonyloxy or phenylcarbonyloxy,
R₁₀ is hydrogen, unsubstituted C₁-C₆-alkyl or C₁-C₆-alkyl substituted by OH— or C₁-C₄alkoxy;
unsubstituted phenyl or phenyl substituted by OH—, C₁-C₄alkyl or C₁-C₄alkoxy.

2. Compounds of the formula Ia-Ie according to claim 1, wherein
R₁ and R₂ are hydrogen;
R₃ is (meth)acryloyloxy-methyl or phenyl para substituted by vinyl,
R₄ is phenyl or phenyl para substituted by vinyl or (meth)acryloyloxy; or
a substituted phenyl residue of the formula —C₆H₄CH₂—W, wherein W is (meth)acryloyloxy, or an aliphatic residue of the formula —CH₂—Y-A, wherein
Y is a bond, O—C₁-C₁₂alkylene, wherein the alkylene linker is linear or branched and may be interrupted once or more than once by oxygen,
A is hydroxy, C₁-C₆alkoxy, acetoxy, (meth)acryloyloxy, or a phthalate or maleate-residue;
R₅ is hydrogen
n is 1;
X is —(CH₂)—.

3. Compounds of the formula Ia-Ie according to claim 2, wherein R₁ and R₂ are hydrogen
R₃ is (meth)acryloyloxy-methyl or phenyl para substituted by vinyl,
R₄ is phenyl or phenyl para substituted by vinyl;
or an aliphatic residue of the formula —CH₂OH, —CH₂-(meth)acryloyloxy, —CH₂-acetoxy or —CH₂—O—C₁-C₁₂alkyl or —CH₂-A, wherein A is a phthalate or maleate-residue;
R₅ is hydrogen
n is 1;
X is —(CH₂)—.

4. A compound of the formula Ib according to claim 1.

5. A coating composition comprising
(2) an alkyd resin,
(3) a reactive diluent of the formula Ia-Ie as defined in claim 1 or mixtures thereof,
(3) 0.3 to 10 wt. % of a mono-, bis- or trisacylphosphinoxide photoinitiator of the formula I 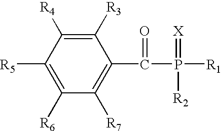
wherein
X is O or S;
R₁ and R₂ independently of one another are linear or branched C₁-C₁₂-alkyl, C₁-C₁₂-alkoxy, phenyl, unsubstituted or substituted by OR₈, SR₉, NR₁₀R₁₁, C₁-C₁₂-Alkyl or halogen; or
R₁ and R₂ are phenyl-C₁-C₄-alkyl or 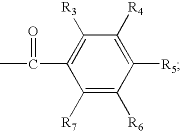
R₃ and R₇ independently of one another are C₁-C₁₂alkyl, C₁-C₁₂-alkoxy or halogen;
R₄, R₅ and R₆ independently of one another are hydrogen, C₁-C₁₂-alkyl, C₁-C₁₂-alkoxy or halogen;
R₈, R₉ R₁₀ and R₁₁ independently of one another are hydrogen, C₁-C₁₂-alkyl, C₂C₁₂-alkenyl, benzyl or C₂C₂₀-alkyl interrupted once or several times by —O—; or R₁₀ and R₁₁ together with the N-atom to which they are attached form a 5 or 6 membered ring which ring may also contain oxygen atom or atoms or NR₁₂;
R₁₂ is hydrogen, phenyl-C₁-C₄-alkyl or C₁-C₁₂-alkyl.

6. Process for preparing compounds of the formula Ia-Ie, wherein a cycloolefin of the formula Ia′-Ie′ 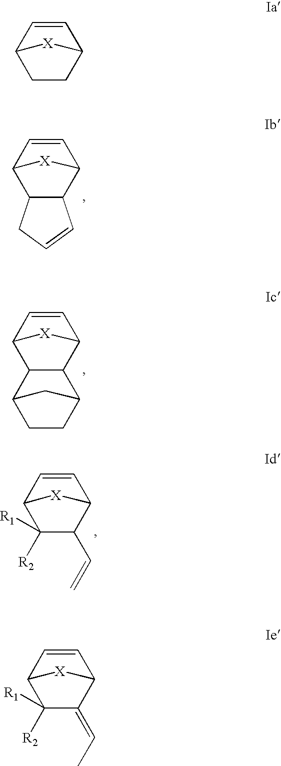
wherein R₁, R₂, are as defined in claim 1 are reacted in the presence of a metathesis catalyst with a terminal olefin of the formula II 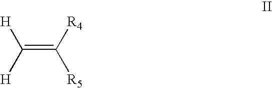
wherein R₄ and R₅ are as defined in claim 1.

7. A decorative or do-it-yourself coating composition according to claim 5, for substrates made of metal, concrete or plastic materials.

8. Solvent-based or water-based alkyd coating composition comprising 0.3 to 10 wt. % of a mono-, bis- or trisacylphosphinoxide photoinitiator of the formula I as defined in claim 5.

9. Solvent-based or water-based alkyd composition according to claim 8, comprising compounds of the formula I′ 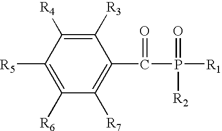
wherein
R₁ and R₂ independently of one another are C₁-C₈-alkyl, C₁-C₆-alkoxy, phenyl that is unsubstituted or substituted by one or two OR₈ or NR₁₀R₁₁; or
R₁ is 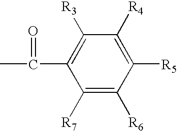
and R₂ is C₁-C₁₂-alkyl or phenyl unsubstituted or optionally substituted by OR₈;
R₃ and R₇ independently of one another are C₁-C₄-alkyl, C₁-C₄-alkoxy, or chlorine;
R₄, R₅ and R₆ independently of one another are hydrogen or C₁-C₄-alkyl,
R₈ is C₁-C₈-alkyl;
R₁₀ and R₁₁ together with the N-atom to which they are attached form a 5 or 6 membered ring which ring may also contain one or more oxygen atoms.

10. Solvent-based or water-based alkyd composition according to claim 9, comprising compounds of the formula I′, 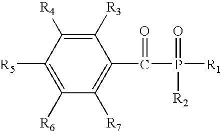
wherein
R₁ and R₂ independently of one another are C₁-C₂-alkoxy or phenyl; or
R₁ is 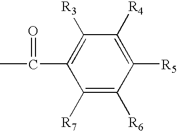
and R₂ is C₁-C₈-alkyl or phenyl that is unsubstituted or optionally substituted by one or two OR₈;
R₃ and R₇ independently of one another are methyl, methoxy, or chlorine;
R₅ is hydrogen or methyl;
R₄ and R₆ are hydrogen,
R₈ is C₁-C₆-alkyl;

11. Composition according to claim 10, wherein the photoinitiator is bis(2,4,6-trimethyl benzoyl)-phenylphosphine oxide.

12. A siccative free or antiskinning agent free alkyd resin composition containing 0.3 to 10 wt. % of a mono-, bis- or trisacylphosphinoxide photoinitiator according to claim 8.

13. A process for curing a solvent-based or water-based alkyd resin according to claim 8 by photochemical treatment with light of a wavelength from 200 to 600 nm.

14. A compound of the formula Ib according to claim 2.

15. A compound of the formula Ib according to claim 3.

16. A sheetfed offset print composition according to claim 5.

17. A method of curing siccative free or antiskinning agent free alkyd resins which method comprises adding 0.3 to 10 wt. % of a mono, bis or trisacylphosphinoxide according to claim 8.
